(19) United States
(12) Patent Application Publication
(10) Pub. No.: US 2021/0293284 A1
(43) Pub. Date: Sep. 23, 2021

(54) METHOD FOR ASSEMBLING CONSTANT VELOCITY JOINT

(71) Applicant: JTEKT CORPORATION, Osaka-shi (JP)

(72) Inventors: Takashi OKAZAKI, Anjo-shi (JP); Noriki KUBOTA, Maibara-shi (JP)

(73) Assignee: JTEKT CORPORATION, Osaka-shi (JP)

(21) Appl. No.: 17/195,782

(22) Filed: Mar. 9, 2021

(30) Foreign Application Priority Data
Mar. 19, 2020 (JP) 2020-049710

(51) Int. Cl. F16D 3/227

(52) U.S. Cl. CPC F16D 3/227; F16D 2300/12; F16D 2250/0084

(57) ABSTRACT

A method for assembling a constant velocity joint includes a first step of inserting a unit in which balls are housed in windows of a cage from one side in a direction of a central axis of an outer joint member toward another side in the direction of the central axis of the outer joint member to allow the balls to roll along outer ball grooves; and a second step of mounting an inner joint member while moving the inner joint member in the outer joint member along the direction of the central axis of the outer joint member.

### CROSS-REFERENCE TO RELATED APPLICATION

This application claims priority to Japanese Patent Application No. 2020-049710 filed on Mar. 19, 2020, incorporated herein by reference in its entirety.

### BACKGROUND

### 1. Technical Field

The disclosure relates to a method for assembling a constant velocity joint.

### 2. Description of Related Art

There has been a cross-groove constant velocity joint disclosed in, for example, Japanese Unexamined Patent Application Publication No. 7-71468 (JP 7-71468 A). In the related-art cross-groove constant velocity joint, both side faces of each outer ball groove of an outer joint member are inclined along a central axis of the outer joint member at a position near an opening end face of the outer joint member, thereby providing straight portions parallel to the central axis.

There has also been a constant velocity joint disclosed in, for example, Japanese Unexamined Patent Application Publication No. 2018-71654 (JP 2018-71654 A). In the related-art constant velocity joint, outer ball grooves and inner ball grooves are arranged such that an inclination direction of the outer ball groove relative to a central axis of an outer joint member is opposite to an inclination direction of the inner ball groove relative to a central axis of an inner joint member. In the related-art constant velocity joint, the inner ball groove has a relief portion to allow a ball to move out of the inner ball groove to one side in a central axis direction of the inner joint member.

### SUMMARY

In general, cross-groove constant velocity joints are assembled by mounting balls, a cage, and an inner joint member from an opening, that is, an inlet opening of an outer joint member similarly to the cross-groove constant velocity joint disclosed in JP 7-71468 A. In the cross-groove constant velocity joint disclosed in JP 7-71468 A, a unit including the balls and the cage or the inner joint member is mounted into the outer ball grooves via the straight portions provided in the outer ball grooves. Thus, the strength of the cage is secured, and good assemblability is attained.

In the constant velocity joint disclosed in JP 2018-71654 A, the ball needs to move to one side along the central axis of the inner joint member, that is, to the inlet opening of the outer joint member via the relief portion. Therefore, when the inner joint member is mounted from the inlet opening of the outer joint member in the constant velocity joint disclosed in JP 2018-71654 A, the inner joint member needs to be mounted in a state in which the other side of the inner joint member on the central axis of the inner joint member faces the outer joint member. Since the outer ball grooves and the inner ball grooves are inclined in the opposite directions, it is difficult to mount the balls, the cage, and the inner joint member into the outer joint member with ease. Thus, there is a demand to improve the assemblability.

The disclosure provides a method for manufacturing a constant velocity joint with good assemblability.

One aspect of the disclosure relates to a method for assembling a constant velocity joint including an outer joint member, an inner joint member, a plurality of balls, and a cage. The outer joint member has outer ball grooves each of which extends in a direction in which the outer ball groove is inclined relative to a central axis of the outer joint member. The inner joint member has inner ball grooves each of which is inclined relative to a central axis of the inner joint member in a direction opposite to the direction in which the outer ball groove is inclined. The balls are supported in a rollable manner on the outer ball grooves and the inner ball grooves arranged to face each other by housing the inner joint member in the outer joint member, and the balls are configured to transmit a torque between the outer joint member and the inner joint member. The cage is arranged between an inner peripheral surface of the outer joint member and an outer peripheral surface of the inner joint member, and the cage has windows each configured to house one of the balls. The method includes a first step of inserting a unit in which the balls are housed in the windows of the cage from one side in a direction of the central axis of the outer joint member toward another side in the direction of the central axis of the outer joint member to allow the balls to roll along the outer ball grooves, and a second step of mounting the inner joint member while moving the inner joint member in the outer joint member along the direction of the central axis of the outer joint member.

According to this method, the inner joint member can be mounted in the outer joint member by arranging, in the outer ball grooves of the outer joint member, the balls of the unit in a rollable manner, and then causing the balls to enter the inner ball grooves. Thus, the balls, the cage, and the inner joint member can be easily mounted in the outer joint member, and the assemblability of the constant velocity joint can be improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a sectional view of a constant velocity joint in a state in which a joint angle is 0 degrees;

FIG. 2 is a diagram for describing formation of a finished portion and a finishing relief portion of an outer ball groove;

FIG. 3 is a diagram for describing a state in which a ball housed in the finishing relief portion of the outer ball groove rolls toward the finished portion;

FIG. 4 is a diagram for describing forces acting on the ball when the ball housed in the finishing relief portion of the outer ball groove rolls toward the finished portion;

FIG. 5 is an enlarged view of the state in FIG. 4;

FIG. 6 is a front view of an inner joint member of the constant velocity joint of FIG. 1;

FIG. 7 is a schematic diagram schematically illustrating the constant velocity joint in a state in which the joint angle is a maximum joint angle;

FIG. 8 is a schematic diagram schematically illustrating the constant velocity joint in a state in which the balls enter gate areas;

FIG. 9 is a schematic diagram schematically illustrating the constant velocity joint in a state in which the balls are guided by gate portions;

FIG. 10 is a schematic diagram schematically illustrating the constant velocity joint in a state in which the balls enter inner ball grooves;

FIG. 11 is a diagram illustrating a state in which the ball housed in the finishing relief portion of the outer ball groove moves to a stepped portion along with movement of the inner joint member; and

FIG. 12 is a diagram illustrating a state in which the ball enters the finished portion beyond the stepped portion along with the movement of the inner joint member.

### DETAILED DESCRIPTION OF EMBODIMENTS

### 1. Structure of Constant Velocity Joint 100

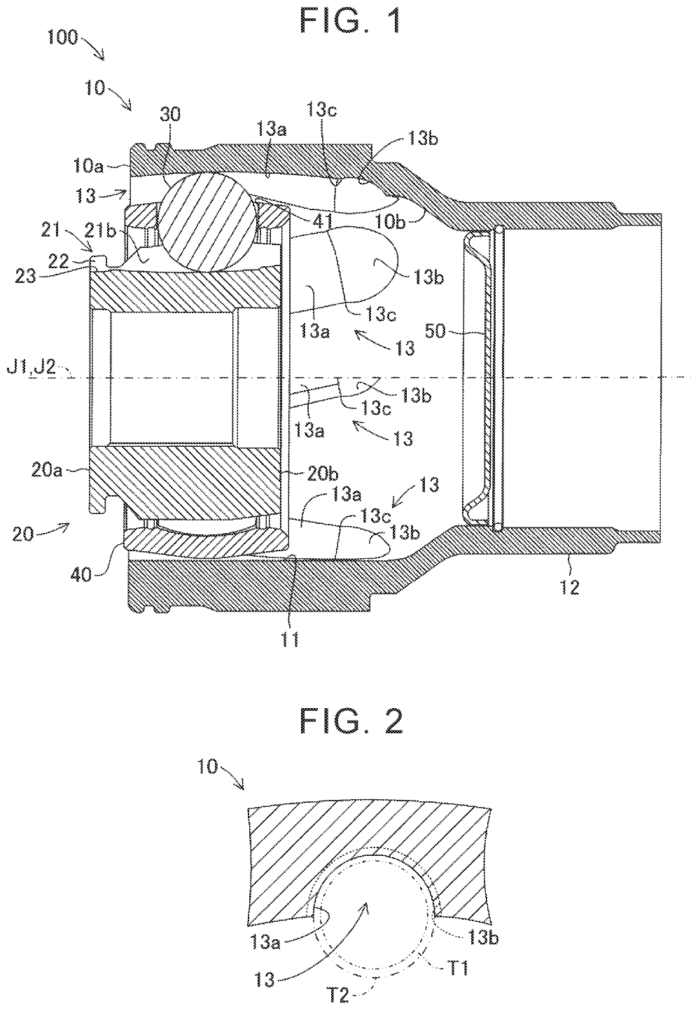

A constant velocity joint 100 is a cross-groove joint, and is slidable in a central axis direction of the joint. As illustrated in FIG. 1, the constant velocity joint 100 mainly includes an outer joint member 10, an inner joint member 20, a plurality of balls 30, a cage 40, and a partition member 50.

As illustrated in FIG. 1, the outer joint member 10 has a conical cylinder shape with two open ends. The outer joint member 10 includes a housing 11 that houses the inner joint member 20, the balls 30, and the cage 40, and a flange 12 having a diameter smaller than that of the housing 11. A plurality of outer ball grooves 13 is formed on the inner peripheral surface of the outer joint member 10 (more specifically, the inner peripheral surface of the housing 11). The outer ball groove 13 extends in a direction in which the outer ball groove 13 is inclined relative to a central axis J1 of the outer joint member 10.

The outer ball groove 13 includes a finished portion 13a and a finishing relief portion 13b. The finished portion 13a serves as a rolling portion where the ball 30 rolls during a normal operation of the constant velocity joint 100. The finishing relief portion 13b serves as a machining relief in the finishing of the finished portion 13a. The finishing relief portion 13b is provided at a deep portion 10b opposite to a slide-in side of the outer joint member 10, that is, an inlet opening 10a of the housing 11 to adjoin the finished portion 13a in the inclination direction of the outer ball groove 13 (i.e., the direction in which the outer ball groove 13 is inclined). The outer ball grooves 13 are formed so that an inclination direction of one outer ball groove 13 relative to the central axis J1 (hereinafter referred to simply as “inclination direction of outer ball groove 13”) is opposite to an inclination direction of another outer ball groove 13 adjacent to the one outer ball groove 13 in a circumferential direction of the outer joint member 10. The outer ball groove 13 is described later in detail.

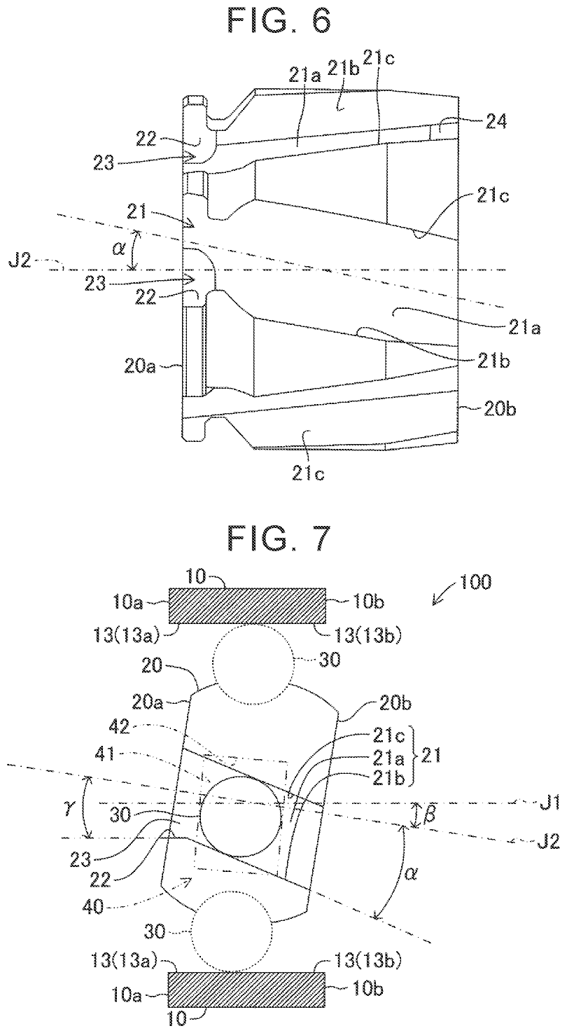

A plurality of inner ball grooves 21 is formed on the outer peripheral surface of the inner joint member 20 (see FIG. 6). The inner ball groove 21 extends in a direction in which the inner ball groove 21 is inclined relative to a central axis J2 of the inner joint member 20. The inner ball grooves 21 are formed so that an inclination direction of one inner ball groove 21 relative to the central axis J2 (hereinafter referred to simply as “inclination direction of inner ball groove 21”) is opposite to an inclination direction of another inner ball groove 21 adjacent to the one inner ball groove 21 in a circumferential direction of the inner joint member 20. The inner ball groove 21 is described later in detail.

As illustrated in FIG. 1, the ball 30 is supported in a rollable manner by the outer ball groove 13 and the inner ball groove 21 arranged to face each other with their inclination directions opposite to each other. Thus, the ball 30 transmits a torque between the outer joint member 10 and the inner joint member 20.

The cage 40 is arranged between the inner peripheral surface of the outer joint member 10 and the outer peripheral surface of the inner joint member 20. As illustrated in FIG. 1, the cage 40 has a minimum inside diameter larger than a maximum outside diameter of the inner joint member 20. The cage 40 has windows 41 each configured to house one ball 30.

The partition member 50 is a disc-shaped member fixed while being press-fitted to the flange 12 of the outer joint member 10. The partition member 50 separates an internal space of the outer joint member 10 from an external space. The internal space of the outer joint member 10 is filled with grease serving as a lubricant. The partition member 50 prevents leakage of the grease to the outside.

FIG. 1 illustrates a state in which a joint angle is 0 degrees. The joint angle is an angle between the central axis J1 of the outer joint member 10 and the central axis J2 of the inner joint member 20. FIG. 1 illustrates a cross section that includes the outer ball groove 13, the inner ball groove 21, the ball 30, and the window 41 of the cage 40 in a part above the central axis J1 of the outer joint member 10 and the central axis J2 of the inner joint member 20. FIG. 1 illustrates a cross section that does not include the outer ball groove 13, the inner ball groove 21, the ball 30, and the window 41 of the cage 40 in a part below the central axis J1 and the central axis J2.

### 2. Details of Outer Ball Groove 13

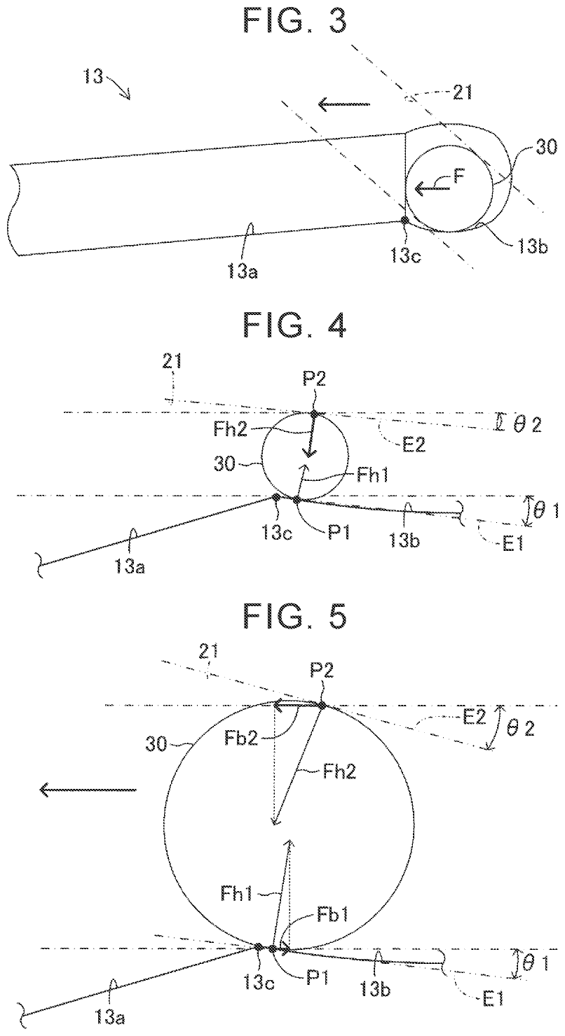

The outer ball groove 13 includes the finished portion 13a and the finishing relief portion 13b. In general, the outer ball groove 13 is roughly machined by using a small-diameter rough machining tool T1 as indicated by an alternate long and two short dashes line in FIG. 2, and then the finished portion 13a is formed by using a large-diameter finishing tool T2 as indicated by an alternate long and short dash line in FIG. 2. For relief of the finishing using the large-diameter finishing tool T2, the finishing relief portion 13b having a groove width and a groove depth larger than those of the finished portion 13a needs to be formed by using the rough machining tool T1 as indicated by a dashed line in FIG. 2. Therefore, the outer ball groove 13 has a stepped portion 13c at a boundary between the finished portion 13a and the finishing relief portion 13b as illustrated in FIG. 3.

In this example, when the constant velocity joint 100 is assembled as described later, the inner joint member 20 is moved toward the inlet opening 10a along the central axis J1 of the outer joint member 10 as indicated by an arrow in FIG. 3 in a state in which each ball 30 is arranged in the finishing relief portion 13b as illustrated in FIG. 3. Thus, the balls 30 are supported in a rollable manner by the outer ball grooves 13 and the inner ball grooves 21, and the assembling of the constant velocity joint 100 is completed. That is, when the constant velocity joint 100 is assembled, each ball 30 arranged in the finishing relief portion 13b needs to be moved from the finishing relief portion 13b toward the finished portion 13a along with the movement of the inner joint member 20.

Specifically, as illustrated in FIG. 3, the ball 30 receives a pressing force F with which the ball 30 is pressed by the inner ball groove 21 along with the movement of the inner joint member 20. Thus, the ball 30 moves from the finishing relief portion 13b to the finished portion 13a by climbing over (i.e., moving beyond) the stepped portion 13c between the finishing relief portion 13b and the finished portion 13a.

As illustrated in FIG. 4, consideration is made about an angle θ1 of a tangent E1 at an outer ball groove-side contact point P1 on the finishing relief portion 13b relative to a moving direction of the inner joint member 20 (lateral direction in FIG. 4), and an angle θ2 of a tangent E2 at an inner ball groove-side contact point P2 on the inner ball groove 21 relative to the moving direction of the inner joint member 20 (lateral direction in FIG. 4). When the angle θ2 is smaller than the angle θ1, an outer ball groove-side pressing force Fh1 acting on the ball 30 from the finishing relief portion 13b and the stepped portion 13c increases along with the movement of the ball 30. Therefore, an inner ball groove-side pressing force Fh2 with which the ball 30 is pressed by the inner joint member 20 increases when the ball 30 climbs over the stepped portion 13c. As a result, the ball 30 is caught at the stepped portion 13c.

When the angle θ2 is larger than the angle θ1 as illustrated in an enlarged view of FIG. 5, the inner ball groove 21 and the finishing relief portion 13b have a relationship in which an action direction of the inner ball groove-side pressing force Fh2 with which the ball 30 is pressed by the inner ball groove 21 at the inner ball groove-side contact point P2 is offset toward the finished portion 13a from an action direction of the outer ball groove-side pressing force Fh1 with which the ball 30 is pressed by the finishing relief portion 13b and the stepped portion 13c at the outer ball groove-side contact point P1. In other words, the magnitude of a component force Fb2 of the inner ball groove-side pressing force Fh2 in the moving direction of the inner joint member 20 (lateral direction in FIG. 5) is larger than the magnitude of a component force Fb1 of the outer ball groove-side pressing force Fh1 in the moving direction of the inner joint member 20 (lateral direction in FIG. 5).

Thus, to form the finishing relief portion 13b of the outer ball groove 13, the inner ball groove 21 and the finishing relief portion 13b need to have the relationship in which the angle θ2 is larger than the angle θ1. With this configuration, when the inner joint member 20 is moved toward the inlet opening 10a of the outer joint member 10, the outer ball groove-side pressing force Fh1 (component force Fb1) acting on the ball 30 from the finishing relief portion 13b and the stepped portion 13c decreases along with the movement of the ball 30.

Thus, the ball 30 can smoothly climb over the stepped portion 13c. Thus, the ball 30 can be moved from the finishing relief portion 13b to the finished portion 13a in the outer ball groove 13 along with the movement of the inner joint member 20. Accordingly, the ball 30 can be supported in a rollable manner by the inner ball groove 21 and the outer ball groove 13, and the constant velocity joint 100 can be assembled.

### 3. Details of Inner Ball Groove 21

Details of the inner ball groove 21 are described with reference to FIG. 6 and FIG. 7. FIG. 6 is a front view of the inner joint member 20. FIG. 7 is a sectional view illustrating a section viewed in a direction orthogonal to a plane passing through the central axis J1 of the outer joint member 10 and the central axis J2 of the inner joint member 20. For simplification of the drawing, FIG. 7 illustrates only one ball 30 located on the nearest side when the inner joint member 20 is viewed in the viewing direction (hereinafter referred to as “in predetermined side view”), and illustration of the other inner ball grooves 21 is omitted.

In FIG. 7, the joint angle is a maximum joint angle β, and an angle of the inclination direction of the inner ball groove 21 relative to the central axis J2 of the inner joint member 20 is an inclination angle α. Although illustration is omitted, the inclination direction of the outer ball groove 13 relative to the central axis J1 of the outer joint member 10 is opposite to the inclination direction of the inner ball groove 21, and an absolute value of an angle of the inclination direction of the outer ball groove 13 (that is, an inclination angle) is substantially equal to an absolute value of the inclination angle α of the inner ball groove 21. In the predetermined side view, the inner ball groove 21 illustrated in FIG. 7 is inclined toward a side opposite to a side toward which the central axis J1 of the outer joint member 10 is inclined with respect to the central axis J2 of the inner joint member 20. That is, the inner ball groove 21 is inclined relative to the central axis J1 of the outer joint member 10 by an angle (α+β) in the predetermined side view.

The inner ball groove 21 has a rolling guide bottom face 21a, a first rolling guide side face 21b, and a second rolling guide side face 21c. The sectional shape of the inner ball groove 21 that is orthogonal to the groove direction is a concave shape. The rolling guide bottom face 21a is a bottom of the concave cross section. The first rolling guide side face 21b is one side face of the concave cross section. The second rolling guide side face 21c is the other side face of the concave cross section.

In FIG. 6, the first rolling guide side face 21b defines a lower ridge of the inner ball groove 21 (opening edge of the inner ball groove 21). In the predetermined side view of FIG. 7, the first rolling guide side face 21b has an acute angle relative to one end face 20a of the inner joint member 20 (i.e., end face 20a on one side) in the direction of the central axis J2. In the predetermined side view, the first rolling guide side face 21b has an obtuse angle relative to the other end face 20b of the inner joint member 20 (i.e., end face 20b on the other side) in the direction of the central axis J2.

In FIG. 6, the second rolling guide side face 21c defines an upper ridge of the inner ball groove 21 (opening edge of the inner ball groove 21). In the predetermined side view of FIG. 7, the second rolling guide side face 21c has an obtuse angle relative to the one end face 20a of the inner joint member 20 in the direction of the central axis J2. In the predetermined side view, the second rolling guide side face 21c has an acute angle relative to the other end face 20b of the inner joint member 20 in the direction of the central axis J2.

The inner joint member 20 has, in addition to the inner ball grooves 21, gate portions 22 that permit the balls 30 to access the inner ball grooves 21. Each gate portion 22 allows the ball 30 to exit from the inner ball groove 21 to one side in the direction of the central axis J2 of the inner joint member 20, or allows the ball 30 to enter the inner ball groove 21 from the one side.

The gate portion 22 is formed between the first rolling guide side face 21b and the one end face 20a of the inner joint member 20 in the direction of the central axis J2. On the assumption that the first rolling guide side face 21b is provided to reach the end face 20a, the gate portion 22 is formed by cutting off a portion of the imaginary first rolling guide side face 21b, the portion being connected to the end face 20a. The area where the gate portion 22 is formed is defined as a gate area 23.

Specifically, the gate portion 22 is a rolling guide side face configured to guide the ball 30 in an inclination direction opposite to the inclination direction of the inner ball groove 21 relative to the central axis J2 of the inner joint member 20. That is, in FIG. 6 and FIG. 7, the inner ball groove 21 is inclined clockwise relative to the central axis J2 of the inner joint member 20, but the gate portion 22 is inclined counterclockwise relative to the central axis J2 of the inner joint member 20, in other words, the gate portion 22 is inclined toward the same side as the side toward which the outer ball groove 13 is inclined. As illustrated in FIG. 7, an inclination angle γ of the gate portion 22 relative to the central axis J2 of the inner joint member 20 is set to be equal to or larger than the maximum joint angle β.

The gate portion 22 of this example is formed only between the first rolling guide side face 21b and the end face 20a. That is, the gate portion 22 of this example is not formed between the first rolling guide side face 21b and the end face 20b, and is not formed between the second rolling guide side face 21c and each of the end face 20a and the end face 20b.

### 4. Assembling of Constant Velocity Joint 100

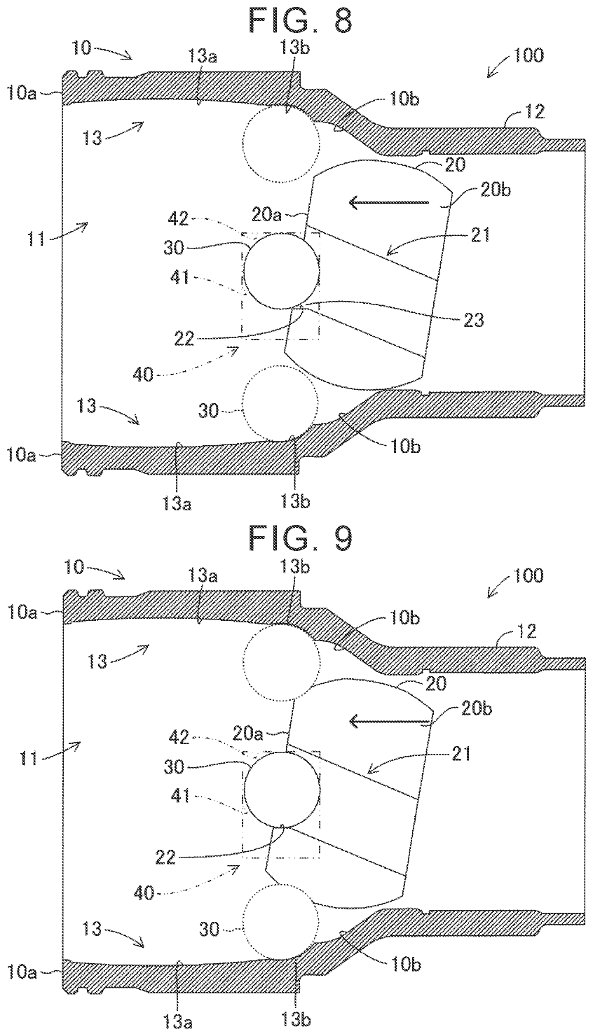

As described above, the finished portion 13a, the finishing relief portion 13b, and the stepped portion 13c of each outer ball groove 13 are formed in the outer joint member 10 of the constant velocity joint 100 so that the angle θ2 is larger than the angle θ1. Further, the inner ball grooves 21 having the gate portions 22 are formed in the inner joint member 20 of the constant velocity joint 100. Therefore, when the constant velocity joint 100 is assembled by housing the inner joint member 20, the balls 30, and the cage 40 in the outer joint member 10, the balls 30 housed in the individual windows 41 of the cage 40 can be caused to enter the inner ball grooves 21 by using the gate portions 22. This operation is described with reference to FIG. 8 to FIG. 12.

When the constant velocity joint 100 is assembled as illustrated in FIG. 8, the balls 30 retained by being housed in the windows 41 of the cage 40 are positioned (i.e., a unit is positioned) in the housing 11 of the outer joint member 10 by inserting, in a rollable manner, the balls 30 (i.e., the unit) into the finishing relief portions 13b of the outer ball grooves 13 of the outer joint member 10 from the inlet opening 10a of the outer joint member 10 (one side in the direction of the central axis J 1) toward the deep portion 10b of the outer joint member 10 (the other side in the direction of the central axis J1) (first step).

In this example, the inner joint member 20 is inserted into the deep portion 10b from the flange 12-side of the outer joint member 10, that is, the deep-side opening of the outer joint member 10. In this case, the inner joint member 20 is housed so that the end face 20a of the inner joint member 20 is oriented to the inlet opening 10a of the outer joint member 10. In this state, the inner joint member 20 is arranged so that the balls 30 are positioned in the gate area 23 as illustrated in FIG. 8. Then, the inner joint member 20 is moved toward the inlet opening 10a along a direction indicated by an arrow, that is, the direction of the central axis J1 of the outer joint member 10 (second step).

At this time, each ball 30 positioned in the gate area 23 rolls toward the inner ball groove 21 while being guided by the gate portion 22 and the outer ball groove 13 as illustrated in FIG. 9 along with the movement of the inner joint member 20. The inclination direction of the gate portion 22 is directed toward the side opposite to the side toward which the inclination direction of the inner ball groove 21 is directed, and is directed toward the same side as the side toward which the inclination direction of the outer ball groove 13 is directed. Thus, the ball 30 rolls while being guided by the outer ball groove 13 and the gate portion 22.

If the inner ball groove 21 does not have the gate portion 22, the ball 30 guided by the outer ball groove 13 is sandwiched between the first rolling guide side face 21b of the inner ball groove 21 and a cage bar 42 of the cage 40. Therefore, the entry of the ball 30 into the inner ball groove 21 is restricted. In this case, it is necessary to increase the size of the window 41 of the cage 40, in other words, reduce the width of the cage bar 42.

In the constant velocity joint 100, the ball 30 positioned in the gate area 23 is guided by the gate portion 22 whose inclination direction is directed toward the same side as the side toward which the inclination direction of the outer ball groove 13 is directed. Thus, the ball 30 can easily enter the inner ball groove 21. That is, circumferential movement of the ball 30 housed in the window 41 is restricted by the cage bars 42 of the cage 40, but rolling (movement) of the ball 30 toward the inner ball groove 21 is permitted by the gate portion 22 guiding the ball 30 along the moving direction of the inner joint member 20. With the gate portion 22 of this example, it is possible to mount the inner joint member 20 without changing the size of the window 41 of the cage 40, that is, while securing the strength of the cage 40.

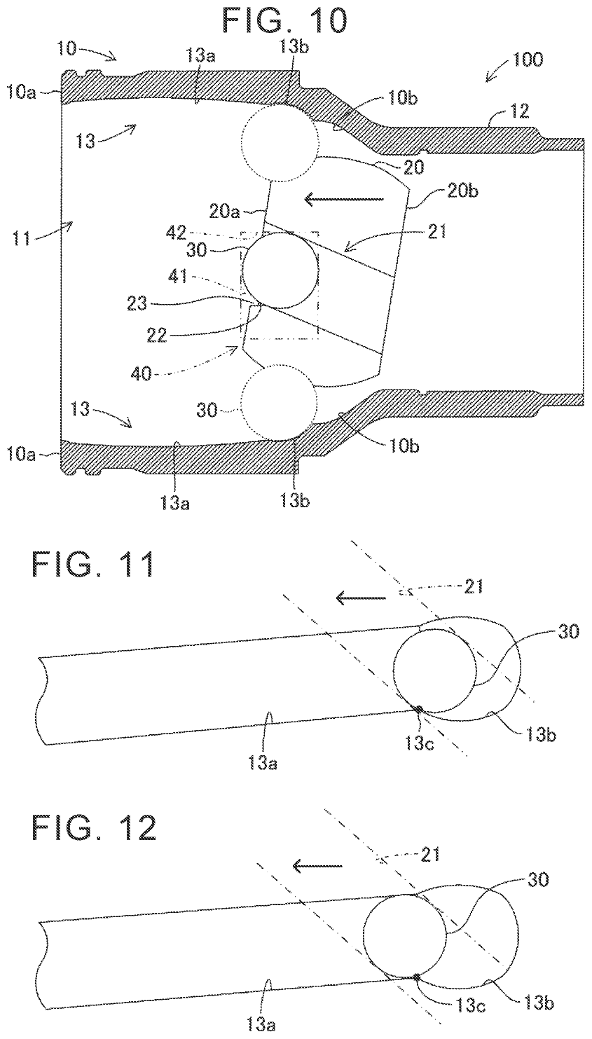

As illustrated in FIG. 10, the ball 30 rolls until the ball 30 contacts the second rolling guide side face 21c of the inner ball groove 21. The ball 30 enters the inner ball groove 21 through the movement of the inner joint member 20 in the direction indicated by the arrow.

When the inner joint member 20 moves in the state in which the ball 30 enters the inner ball groove 21, the ball 30 housed in the finishing relief portion 13b of the outer ball groove 13 starts to move as illustrated in FIG. 11, and moves to the stepped portion 13c. The outer ball groove 13 has the finishing relief portion 13b so that the angle 02 is larger than the angle θ1.

Along with the movement of the inner joint member 20, the ball 30 easily climbs over the stepped portion 13c to enter the finished portion 13a as illustrated in FIG. 12. Thus, the ball 30 is supported in a rollable manner by the outer ball groove 13 and the inner ball groove 21 inclined in the directions opposite to each other. Accordingly, the assembling of the constant velocity joint 100 is completed.

As understood from the above description, according to the method for assembling the constant velocity joint 100, the inner joint member 20 can be mounted in the outer joint member 10 by arranging, in the outer ball grooves 13 of the outer joint member 10, the balls 30 housed in the windows 41 of the cage 40 in a rollable manner, and causing the balls 30 to enter the inner ball grooves 21 via the gate portions 22. Thus, the balls 30, the cage 40, and the inner joint member 20 can be easily mounted in the outer joint member 10, and the assemblability of the constant velocity joint 100 can be improved.

### 5. Others

In this example, the outer joint member 10 has the conical cylinder shape in which the housing 11 has a large diameter and the flange 12 has a small diameter. The shape of the outer joint member 10 is not limited to the conical cylinder shape, and may be, for example, a cylindrical shape with two open ends. Alternatively, the shape of the outer joint member 10 may be, for example, a bottomed cylinder shape (so-called cup shape) in which one of two ends on the other side in the direction of the central axis J1 is closed.

Also in this case, the inner joint member 20 having the gate portions 22 in the inner ball grooves 21 is arranged at the deep portion 10b of the outer joint member 10 in the first step similarly to the above-mentioned example. In other words, in the first step, the inner joint member 20 is arranged on the other side in the direction of the central axis of the outer joint member 10 so as to be on an opposite side of the finishing relief portions 13b of the outer ball grooves 13 from the finished portions 13a of the outer ball grooves 13, before the unit in which the balls 30 are housed in the cage 40 is inserted into the outer joint member 10. The inner joint member 20 is moved toward the inlet opening 10a of the outer joint member 10 in a state in which the balls 30 retained by the cage 40 are housed in the finishing relief portions 13b of the outer ball grooves 13. Thus, the constant velocity joint 100 can be assembled. Since the constant velocity joint 100 can be assembled in this case as well, effects similar to those in the above-mentioned example are attained.

In the above-mentioned example, the gate portions 22 are provided in the inner ball grooves 21 of the inner joint member 20. However, the gate portions 22 may be omitted from the inner ball grooves 21. Even in the case where the gate portions 22 are not provided in the inner ball grooves 21, the inner joint member 20 can be mounted in the housing 11 of the outer joint member 10 by, for example, moving the inner joint member 20 from the deep portion 10b of the outer joint member 10 similarly to the above-mentioned example.

In the case where the gate portions 22 are not provided in the inner ball grooves 21, the entry of each ball 30 into the inner ball groove 21 is restricted because the ball 30 is sandwiched between the first rolling guide side face 21b of the inner ball groove 21 and the cage bar 42 of the cage 40. In this case, for example, the circumferential width of the cage bar 42 is reduced (that is, the size of the window 41 is increased). Thus, the inner joint member 20 can be mounted in the housing 11 of the outer joint member 10 by moving the inner joint member 20 from the deep portion 10b of the outer joint member 10 though the strength of the cage 40 may decrease.

What is claimed is:

1. A method for assembling a constant velocity joint including:
an outer joint member having outer ball grooves each of which extends in a direction in which the outer ball groove is inclined relative to a central axis of the outer joint member;
an inner joint member having inner ball grooves each of which is inclined relative to a central axis of the inner joint member in a direction opposite to the direction in which the outer ball groove is inclined;
a plurality of balls supported in a rollable manner on the outer ball grooves and the inner ball grooves arranged to face each other by housing the inner joint member in the outer joint member, the balls being configured to transmit a torque between the outer joint member and the inner joint member; and
a cage arranged between an inner peripheral surface of the outer joint member and an outer peripheral surface of the inner joint member, the cage having windows each configured to house one of the balls,
the method comprising:
a first step of inserting a unit in which the balls are housed in the windows of the cage from one side in a direction of the central axis of the outer joint member toward another side in the direction of the central axis of the outer joint member to allow the balls to roll along the outer ball grooves; and
a second step of mounting the inner joint member while moving the inner joint member in the outer joint member along the direction of the central axis of the outer joint member.

2. The method for assembling the constant velocity joint according to claim 1, wherein: each of the outer ball grooves of the constant velocity joint includes
a finished portion that is finished to allow the ball to roll along with an operation of the constant velocity joint, and
a finishing relief portion adjoining the finished portion and located on the other side relative to the finished portion in the direction of the central axis of the outer joint member; and
in the first step, the balls are positioned at the finishing relief portions by inserting the unit toward the other side in the direction of the central axis of the outer joint member.

3. The method for assembling the constant velocity joint according to claim 2, wherein:
the outer joint member has openings respectively located at both ends in the direction of the central axis of the outer joint member; and
in the first step, the inner joint member is inserted into the outer joint member from a deep-side opening that is one of the openings after the unit is inserted into the outer joint member from an inlet opening that is another of the openings.

4. The method for assembling the constant velocity joint according to claim 2, wherein:
the outer joint member is closed on the other side in the direction of the central axis of the outer joint member; and
in the first step, the inner joint member is arranged on the other side in the direction of the central axis of the outer joint member so as to be on an opposite side of the finishing relief portions of the outer ball grooves from the finished portions of the outer ball grooves, before the unit is inserted into the outer joint member.

5. The method for assembling the constant velocity joint according to claim 1, wherein:
the constant velocity joint includes gate portions configured to allow the balls to move out of the inner ball grooves to one side in a direction of the central axis of the inner joint member, and configured to allow the balls to enter the inner ball grooves from the one side in the direction of the central axis of the inner joint member; and
in the second step, the inner joint member is mounted by causing the balls of the unit to enter the inner ball grooves via the gate portions while moving the inner joint member in the outer joint member from the other side in the direction of the central axis of the outer joint member to the one side in the direction of the central axis of the outer joint member.
